(19) United States
(12) Patent Application Publication
(10) Pub. No.: US 2013/0314319 A1
(43) Pub. Date: Nov. 28, 2013

(54) APPARATUS AND METHOD FOR SENSING IMAGE

(71) Applicant: ELECTRONICS AND TELECOMMUNICATIONS RESEARCH IN, Daejeon-city (KR)

(72) Inventor: Jeong-Dae SUH, Daejeon (KR)

(73) Assignee: Electronics and Telecommunications Research Institute, Daejeon-city (KR)

(21) Appl. No.: 13/693,092

(22) Filed: Dec. 4, 2012

(30) Foreign Application Priority Data
May 22, 2012 (KR) 10-2012-0054267

(51) Int. Cl. G06F 3/03

(52) U.S. Cl. CPC G06F 3/0304
USPC 345/158

(57) ABSTRACT

The present invention relates to an apparatus and method for sensing an image formed by a fluid that is wetted to a real paint brush, such as water. The image sensing apparatus includes an input unit configured to receive an image using a paint brush that is wet with a fluid, a light source unit configured to emit infrared light to the input unit for sensing the image, and a sensing unit configured to sense scattered light generated in response to the image received by the input unit using the wet paint brush and to image sensed results.

### CROSS-REFERENCE TO RELATED APPLICATION

This application claims priority to Korean Patent Application No. 10-2012-0054267, filed on May 22, 2012, which is incorporated herein by reference in its entirety.

### BACKGROUND OF THE INVENTION

1. Field of the Invention

Exemplary embodiments of the present invention relate to an apparatus and method for sensing an image and, particularly, to an apparatus and method for sensing an image formed by a fluid that is wetted to a real paint brush, such as water.

2. Description of Related Art

In general, a method of drawing a picture is to paint a picture on a canvas using a wet paint brush on which paint has been applied. A method of drawing a picture in a digital canvas system is to draw a picture using a mouse or a stylus pen on an input screen. Furthermore, there is a digital canvas that uses a tool for drawing a picture in which a paint brush effect is reproduced through software, but this method is disadvantageous in that an effect and feeling with which an actual artist seems to draw a picture on a canvas cannot be obtained.

Traditionally, a method of drawing a picture usually involved using a paint brush with paint on a canvas. However, in a method of drawing a digital picture using a computer, it is difficult to experience or reproduce an actual sensation of drawing a picture using a real paint brush because the picture is drawn using a mouse or a stylus pen.

For example, a method of inputting an image by measuring the electric capacitance of a contact surface using an input plate formed of an insulating layer and an electronic paint brush and a method of inputting an image using touch recognition software based on a touch pad, such as methods disclosed in Korean Patent Registration No. 0172895 entitled “Input Plate Structure of Electronic Brush And Method For Manufacturing Thereof” and Korean Patent Laid-Open Publication No. 2006-0084945 entitled “Method Of Generating Brush Touch Effect Using Touch Pad” do not suggest a method of inputting an image using a real paint brush and a fluid, such as water, and have a disadvantage in that they cannot obtain an effect and feeling with which an actual artist seems to draw a picture on a canvas.

### SUMMARY OF THE INVENTION

An embodiment of the present invention is directed to providing an apparatus and method for sensing an image formed by a fluid that is wetted to a real paint brush, such as water.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an image sensing apparatus includes an input unit configured to receive an image using a paint brush that is wet with a specific fluid, a light source unit configured to emit infrared light to the input unit for sensing the image, and a sensing unit configured to sense scattered light generated in response to the image received by the input unit using the wet paint brush and to image sensed results.

When a user inputs the image to the input unit using the wet paint brush, the wet paint brush may come in contact with the input unit and the scattered light may be generated when total reflection is broken in a region of the input unit in which the wet paint brush comes in contact with the input unit.

The input unit may correspond to an input plate in which the infrared light corresponding to the output of the light source unit is subject to waveguide in total reflection.

The input plate may correspond to a transparent plate made of acryl.

The input plate may have a thickness of 0.6 mm or more to 1 mm or less.

The sensing unit may sense the scattered light using a camera and consecutively image the sensed results.

The camera may be vertically disposed under the input unit.

The light source unit may generate the total reflection within the input unit by emitting the infrared light to the input unit using one or more infrared Light Emitting Diodes (LEDs).

In accordance with another embodiment of the present invention, an image sensing method includes receiving, by an input plate, an image using a paint brush that is wet with a fluid, emitting infrared light to the input plate using a light source for sensing the image, and sensing scattered light generated in response to the image in the input plate and imaging sensed results.

The scattered light may be generated when total reflection is broken in a region of the input plate in which the wet paint brush comes in contact with the input plate.

The input plate may correspond to a transparent plate made of acryl.

The sensing scattered light generated in response to the image in the input plate and imaging sensed results may include sensing the scattered light using a camera and imaging the sensed results.

The camera may be vertically disposed under the input plate.

### BRIEF DESCRIPTION OF THE DRAWINGS

FIG. 1 shows a schematic construction of an image sensing apparatus in accordance with an embodiment of the present invention.

FIG. 2 is a block diagram of the image sensing apparatus in accordance with an embodiment of the present invention.

FIGS. 3 to 5 are a side sectional view and front sectional view of the image sensing apparatus in accordance with an embodiment of the present invention.

FIG. 6 is a flowchart illustrating a method of sensing an image formed by a fluid that is wetted to a real paint brush, such as water, in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

An apparatus and method for sensing an image in accordance with embodiments of the present invention are described below in more detail with reference to the accompanying drawings.

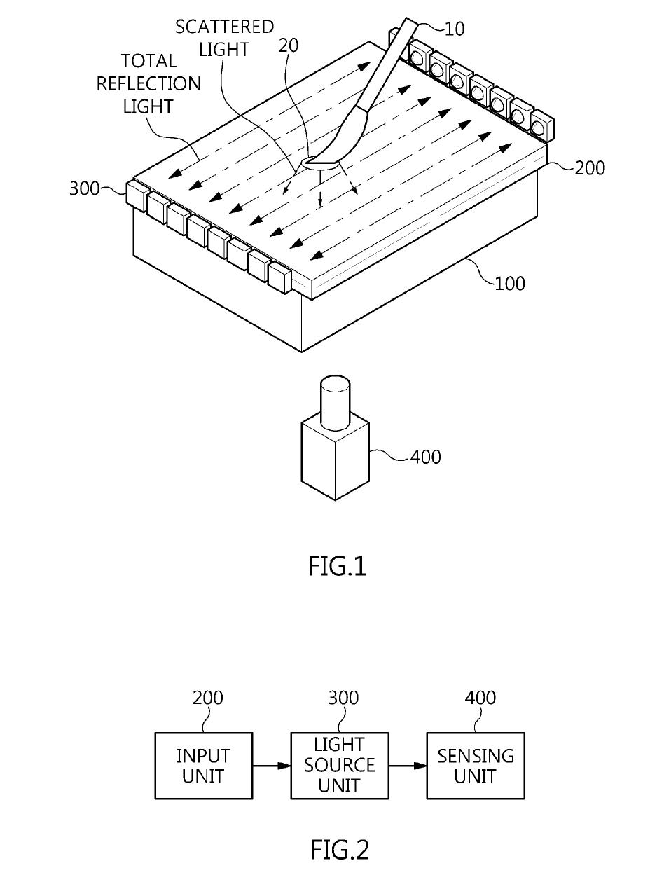

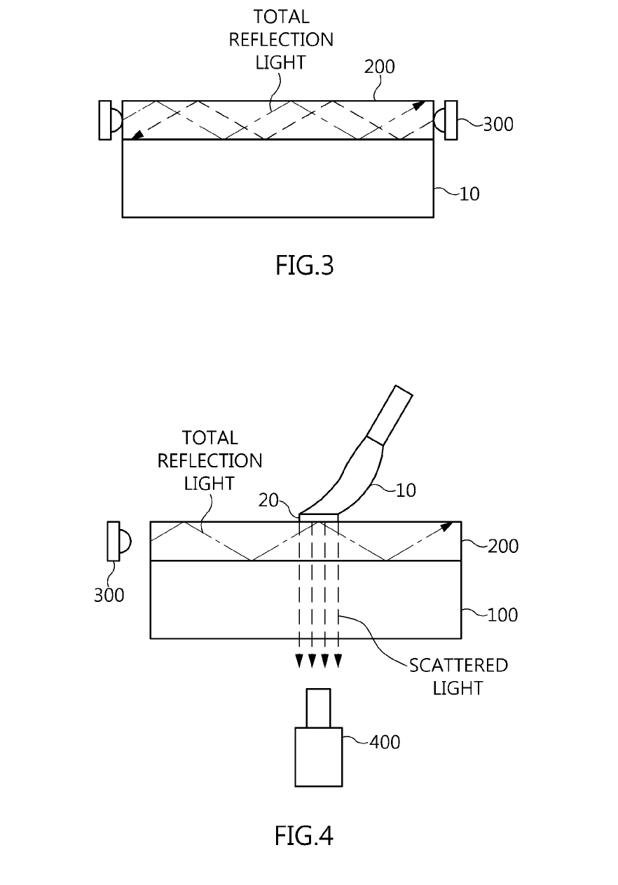

FIG. 1 shows a schematic construction of an image sensing apparatus in accordance with an embodiment of the present invention, FIG. 2 is a block diagram of the image sensing apparatus in accordance with an embodiment of the present invention, and FIGS. 3 to 5 are a side sectional view and front sectional view of the image sensing apparatus in accordance with an embodiment of the present invention.

Referring to FIG. 1, the image sensing apparatus includes a support plate 100, an input unit 200, a light source unit 300, and a sensing unit 400.

The input unit 200 receives an image using a real paint brush 10 that is wet with a fluid 20, such as water. To this end, the input unit 200 is an input plate from which the output of the light source unit 300, that is, infrared light, is subject to waveguide in total reflection. A transparent plate made of acryl is used as the input unit 200. Here, the transparent plate can have a thickness of ¼ inches, that is, about 0.6 to 1 mm, but not limited thereto.

The light source unit 300 emits infrared light for sensing an image of the real paint brush 10 that comes in contact with the input unit 200 to the input unit 200. To this end, the light source unit 300 generates total reflection within the input unit 200 using one or more high-output infrared Light Emitting Diodes (LEDs). Here, the high-output infrared LED may have a wavelength of 880 nm or 950 nm, but it is not limited thereto.

The infrared light emitted by the light source unit 300 is subject to total reflection within the input unit 200. The infrared light subjected to total reflection within the input unit 200, that is, total reflection light, is confined within the input unit 200 and propagated therein as shown in FIG. 3.

The infrared light is confined within the input unit 200 and propagated therein before the real paint brush 10 comes in contact with the input unit 200 as shown in FIG. 3. If the real paint brush 10 that is wet with the fluid 20, such as water, comes in contact with the input unit 200 as shown in FIGS. 4 and 5, however, the total reflection of the infrared light within the input unit 200 is broken. Thus, part of the infrared light is scattered in a region with which the real paint brush 10 comes in contact (i.e., a region in which the fluid 20 is placed), thus generating scattered light.

The sensing unit 400 senses the scattered light generated in response to an image of the real paint brush 10 that is wet with the fluid 20, such as water, and consecutively images sensing results. To this end, the sensing unit 400 may have a form, such as an image camera.

Referring to FIG. 4, the image camera in accordance with an embodiment of the present invention is vertically disposed under the input unit 200 and is configured to sense the infrared light scattered from the input unit 200, that is, the scattered light. Furthermore, the image camera can be disposed under the input unit 200 using an optical element, such as a mirror, so that the distributed infrared rays can be sensed at other places.

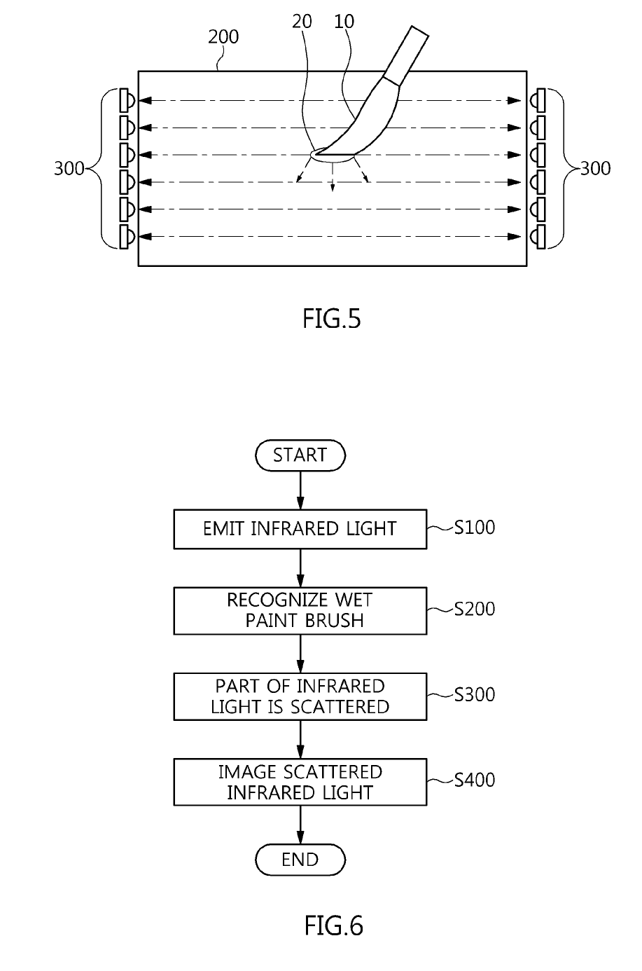

A method of sensing an image that is formed by a fluid, such as water, that is wetted to the real paint brush is described below in detail with reference to FIG. 6.

FIG. 6 is a flowchart illustrating the method of sensing an image formed by a fluid that is wetted to the real paint brush, such as water, in accordance with an embodiment of the present invention.

First, the image sensing apparatus is an apparatus for sensing an image formed by a fluid that is wetted to the real paint brush, such as water. The apparatus includes the light source unit 300 of an array form and the input unit 200 of an input plate form over the support plate 100. Here, the light source unit 300 includes one or more high-output infrared LEDs.

Referring to FIG. 6, the image sensing apparatus emits infrared light to the input plate 200 using the one or more high-output infrared LEDs at step S100. Here, the high-output infrared LED may have a wavelength of 880 nm or 950 nm, but it is not limited thereto. The emitted infrared light is subject to total reflection within the input unit 200, and the total reflection light is confined within the input unit 200 and propagated therein.

In the image sensing apparatus in accordance with the embodiment of the present invention, the infrared light is confined within the input unit 200 and propagated therein before the real paint brush 10 comes in contact with the input unit 200. If the real paint brush 10 that is wet with the fluid 20, such as water, comes in contact with the input unit 200, however, the total reflection of the infrared light within the input unit 200 is broken. Thus, part of the infrared light is scattered in a region with which the real paint brush 10 comes in contact (i.e., a region in which the fluid 20 is placed), thus generating scattered light.

The image sensing apparatus recognizes the wet paint brush 10 that is wet with the fluid 20, such as water, at step S200. When the image sensing apparatus recognizes the wet paint brush 10, part of the infrared light is scattered in the region in which the wet paint brush 10 comes in contact with the input unit 200 at step S300.

The image sensing apparatus senses the scattered infrared light and consecutively images sensing results at step S400.

As described above, in accordance with the present invention, the input plate receives an image using a paint brush that is wet with a specific fluid, infrared light for sensing the image using a light source is emitted to the input plate, scattered light generated in response to the image in the input plate is sensed, and sensed results are imaged. Accordingly, a digital canvas with an improved and realistic sensation of drawing a picture which is impossible to embody using a mouse or a stylus pen can be embodied.

In accordance with the embodiments of the present invention, the apparatus and method for sensing an image can embody a digital canvas with a realistic sensation of drawing a picture which is impossible to embody using a mouse or a stylus pen, using a real paint brush, a fluid, such as water, and a touch screen.

Furthermore, the present invention can embody a digital canvas with an improved realistic sensation using a real paint brush by applying the present invention to a touch screen having a touch function.

While the present invention has been described with respect to the specific embodiments, it will be apparent to those skilled in the art that various changes and modifications may be made without departing from the spirit and scope of the invention as defined in the following claims.

What is claimed is:

1. An image sensing apparatus, comprising:
an input unit configured to receive an image using a paint brush that is wet with a fluid;
a light source unit configured to emit infrared light to the input unit for sensing the image; and
a sensing unit configured to sense scattered light generated in response to the image received by the input unit using the wet paint brush and to image sensed results.

2. The image sensing apparatus of claim 1, wherein the scattered light is generated when total reflection is broken at a boundary surface corresponding to the wet paint brush's touch with the input unit.

3. The image sensing apparatus of claim 1, wherein the input unit corresponds to an input plate in which the infrared light corresponding to an output of the light source unit is kept by total reflection, the input plate act as a waveguide when there is no input image using the paint brush.

4. The image sensing apparatus of claim 3, wherein the input plate corresponds to a transparent plate made of acryl.

5. The image sensing apparatus of claim 3, wherein the input plate has a thickness between 0.6 mm and 1 mm.

6. The image sensing apparatus of claim 1, wherein the sensing unit senses the scattered light using a camera and consecutively images the sensed results.

7. The image sensing apparatus of claim 6, wherein the camera is vertically disposed under the input unit.

8. The image sensing apparatus of claim 1, wherein the light source unit generates total reflection within the input unit by emitting the infrared light to the input unit using one or more infrared Light Emitting Diodes (LEDs).

9. An image sensing method, comprising:
receiving, by an input plate, an image using a paint brush that is wet with a fluid;
emitting infrared light to the input plate using a light source for sensing the image; and
sensing scattered light generated in response to the image in the input plate and imaging sensed results.

10. The image sensing method of claim 9, wherein the scattered light is generated when total reflection is broken at a boundary surface corresponding to the wet paint brush's touch with the input unit.

11. The image sensing method of claim 9, wherein the input plate corresponds to a transparent plate made of acryl.

12. The image sensing method of claim 9, wherein the sensing scattered light generated in response to the image in the input plate is performed using a camera.

13. The image sensing method of claim 12, wherein the camera is vertically disposed under the input plate.
